(19) United States
(12) Patent Application Publication
(10) Pub. No.: US 2026/0307412 A1
(43) Pub. Date: Oct. 8, 2026

(54) ELECTRICAL DEVICE

(71) Applicant: CANON KABUSHIKI KAISHA, Tokyo (JP)

(72) Inventors: YUSUKE NAKAJIMA, Kanagawa (JP); KANETO TOKUYAMA, Tokyo (JP); TAKAYUKI NAKAJIMA, Kanagawa (JP); TORU YADA, Kanagawa (JP); TAKEHIRO NAKATA, Tokyo (JP); RYO TAKANO, Kanagawa (JP); MASAYA SHIMMACHI, Kanagawa (JP); YASUHITO TSUBAKIMOTO, Tokyo (JP); MOTOYUKI TAGUCHI, Tokyo (JP)

(21) Appl. No.: 19/636,402

(22) Filed: Apr. 1, 2026

(30) Foreign Application Priority Data
Apr. 8, 2025 (JP) 2025-063890

(51) Int. Cl. B41J 29/56; B41J 2/175; B41J 29/02; B41J 29/13

(52) U.S. Cl. CPC B41J 29/56; B41J 2/17503; B41J 29/02; B41J 29/13

(57) ABSTRACT

An electrical device includes a main body including a storage unit in which consumables are stored, a cover member supported by the main body so as to be displaceable between a first position to over the storage unit and a second position to expose the storage unit, a restricting member provided on the main body so as to be displaceable between a restriction position to restrict displacement of the cover member from the first position to the second position and a restriction releasing position to release the restriction of the displacement of the cover member, and a slot formed in a housing of the main body, into which a locking member is inserted to prevent the restricting member from displacing from the restriction position to the restriction releasing position.

### BACKGROUND

### Field of the Technology

The present disclosure relates to an electrical device.

### Description of the Related Art

Consumables incorporated in an electrical device need to be replenished when consumed. To do this, the electrical device has a structure for enabling replenishment and exchange of consumables. As a result, the consumables are sometimes taken out from the electrical device without permission. Japanese Patent Laid-Open No. 2018-103528 discloses a printing apparatus having a structure capable of locking an opening/closing cover that opens/closes a space of a housing to store a container storing ink.

In the structure of Japanese Patent Laid-Open No. 2018-103528, the corner portions of the housing adjacent to the opening/closing cover need to have a curved surface. There is room for improvement because there are limitations on applicable housings.

### SUMMARY

The present disclosure provides a technique that improves the degree of freedom of application targets concerning a lock structure for a cover member.

According to one aspect of the present disclosure, there is provided an electrical device comprising: a main body including a storage unit in which consumables are stored; a cover member supported by the main body so as to be displaceable between a first position to over the storage unit and a second position to expose the storage unit; a restricting member provided on the main body so as to be displaceable between a restriction position to restrict displacement of the cover member from the first position to the second position and a restriction releasing position to release the restriction of the displacement of the cover member; and a slot formed in a housing of the main body, into which a locking member is inserted to prevent the restricting member from displacing from the restriction position to the restriction releasing position.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing the outer appearance of a printing apparatus according to an embodiment of the present disclosure;

FIG. 2 is a view showing a mode in which a cover member is opened in the printing apparatus shown in FIG. 1;

FIG. 3 is a schematic view of the internal structure of the printing apparatus shown in FIG. 1;

FIGS. 4A and 4B are partial cutaway views showing the opening/closing mechanism of the cover member;

FIGS. 5A and 5B are explanatory views of a restricting mechanism and a slot;

FIGS. 6A and 6B are explanatory views of the restricting mechanism and the slot in a state in which a panel is detached;

FIGS. 7A and 7B are perspective views of the periphery of the restricting mechanism and the slot;

FIG. 8A is a view showing a mode in which a locking tool is attached to the slot; and

FIG. 8B is a perspective view showing a cross section taken along a line A-A in FIG. 8A.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Outline of Apparatus

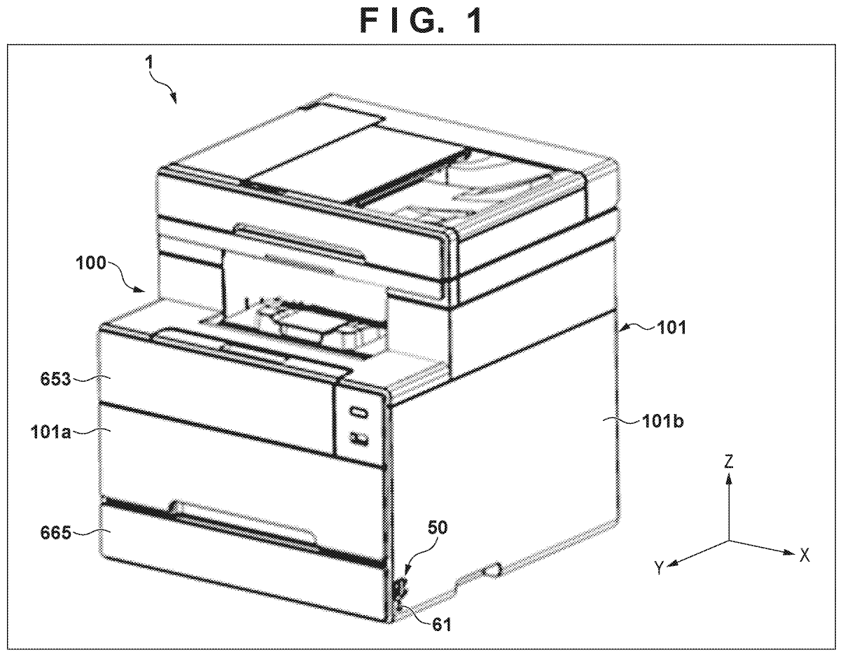

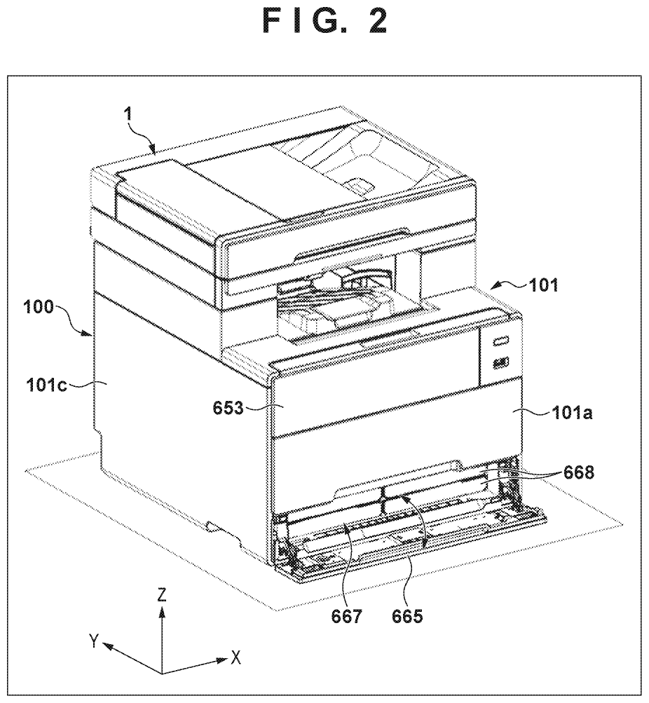

FIGS. 1 and 2 are views showing the outer appearance of an electrical device according to an embodiment of the present disclosure. In this embodiment, a printing apparatus 1 will be exemplified as the electrical device. The printing apparatus 1 is an inkjet printing apparatus configured to discharge liquid ink to a printing medium to perform printing. However, the present disclosure can also be applied to various kinds of electrical devices other than printing apparatuses.

Note that “print” includes not only forming significant information such as characters and graphics but also forming images, figures, patterns, and the like on printing media in a broad sense, or processing media, regardless of whether the information is significant or insignificant or whether the information is visualized so that a human can visually perceive it. In addition, although in this embodiment, sheet-like paper is assumed as a “printing medium”, cloth, a plastic film, and the like may also be used.

In the drawings, arrows X, Y, and Z indicate directions crossing each other. The arrows X and Y indicate horizontal directions that are orthogonal to each other, and the arrow Z indicates the up/down direction. The X direction corresponds to the left/right direction (the lateral direction or the widthwise direction) of the printing apparatus 1, and the Y direction corresponds to the front/rear direction (the depth direction) of the printing apparatus 1. The Z direction corresponds to the height direction (up/down direction) of the printing apparatus 1. Also, the downstream side and the upstream side are defined based on the conveyance direction of a printing medium as a reference.

The printing apparatus 1 includes a main body 100, and a cover member 665 supported by the main body 100. The main body 100 includes a box-shaped housing 101 that forms the outer wall. The housing 101 includes panel members that form a front surface 101a and left and right side surfaces 101b and 101c of the printing apparatus 1.

The cover member 665 can displace between a closing position shown in FIG. 1 and an opening position shown in FIG. 2. The main body 100 includes a storage portion 667 that stores a plurality of tanks 668 containing inks that are consumables. The tanks 668 each have, for example, a pack form, and are placed on a tray and stored in the storage portion 667. Types of inks stored in the plurality of tanks 668 are, for example, black, cyan, magenta, and yellow. If the four types of inks are used, four tanks 668 are stored in the storage portion 667.

At the closing position shown in FIG. 1, the cover member 665 covers the storage portion 667. In this state, the cover member 665 forms a part of the front surface 101a. Also, access from the outside to the storage portion 667 is impossible, and the tanks 668 cannot be taken out. At the opening position shown in FIG. 2, the cover member 665 exposes the storage portion 667. In this state, access from the outside to the storage portion 667 is possible, and the tanks 668 can be taken out or exchanged.

In the front portion of the side surface 101b of the housing 101, a restricting mechanism 50 that restricts displacement of the cover member 665 and a slot 61 usable as a security hole are provided. When a locking tool is attached to the slot 61, the cover member 665 can be locked. When these are arranged on the side surface 101b of the housing 101, the outer appearance of the printing apparatus 1 is not greatly affected. In addition, when these are arranged in the front portion of the side surface 101b, the operability of a user can be improved. Details of these will be described later. Note that in this embodiment, the security hole is provided on the side surface 101b, but a similar configuration may be provided in the front portion of the side surface 101c. The security hole may be provided on both the side surface 101b and the side surface 101c.

### Internal Mechanism of Main Body

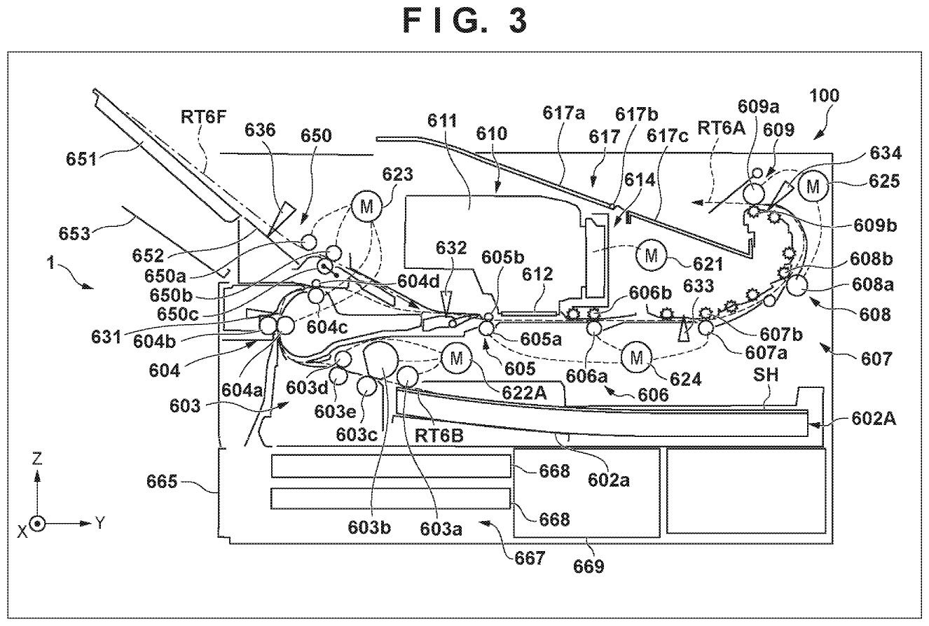

The internal mechanism of the main body 100 will be described with reference to FIG. 3. The printing apparatus 1 conveys a sheet SH stored in a storage cassette 602A and performs printing on the sheet SH. When performing printing on the sheet SH stored in the storage cassette 602A, the sheet SH is conveyed in the order of conveyance path RT6B→conveyance path RT6A, and printing is performed in the process of conveyance.

A configuration for conveying the sheet SH will be described next. The printing apparatus 1 includes a feeding unit 603, a feeding unit 604, and a plurality of conveying units 605 to 609. The feeding unit 603, the feeding unit 604, and the conveying units 605 to 609 are arranged in this order from the upstream side to the downstream side in the conveyance direction of the sheet SH in the conveyance path RT6B and the conveyance path RT6A. Image formation (printing) for the sheet SH is performed by a printing unit 610 between the conveying unit 605 and the conveying unit 606.

The sheet SH on a feeding tray 602a is fed one by one by the feeding unit 603. The feeding unit 603 is a pickup mechanism that picks up the sheet SH from the feeding tray 602a using a feeding motor 622A as a driving source. The feeding unit 603 includes a feeding roller (pickup roller) 603a, a feeding roller 603b, a separation roller 603c, a feeding roller 603d, and a driven roller 603e that forms a nip with the feeding roller 603d.

The feeding roller 603a contacts the uppermost surface of the sheet SH stacked on the feeding tray 602a and is rotated by the driving force of the feeding motor 622A, thereby starting feeding the sheet SH. The feeding roller 603b that is rotated by the driving force of the feeding motor 622A and the separation roller 603c that forms a nip portion with the feeding roller 603b are arranged on the downstream side of the feeding roller 603a. The separation roller 603c is a roller that includes a torque limiter and has a rotational resistance. If two or more sheets SH enter the nip portion between the feeding roller 603b and the separation roller 603c, the sheet SH is separated one by one by the rotational resistance of the separation roller 603c.

The separated sheet SH is conveyed to the feeding roller 603d and the driven roller 603e on the downstream side. The feeding roller 603d uses the feeding motor 622A as the driving source.

The feeding unit 604 conveys the sheet SH fed by the feeding unit 603 to the conveying unit 605. The feeding unit 604 includes feeding rollers 604a and 604c. The feeding rollers 604a and 604c are rotating bodies that are rotated by the driving force of a feeding motor 623. The feeding rollers 604a and 604c are in pressure contact with corresponding driven rollers 604b and 604d to form nip portions. The driven rollers 604b and 604d are rotating bodies following the rotation of the feeding rollers 604a and 604c.

The sheet SH is clamped in the nip portion between the feeding roller 604a and the driven roller 604b and the nip portion between the feeding roller 604c and the driven roller 604d and conveyed by the rotation of these.

Note that the feeding rollers 603a, 603b, and 603d are one-way rollers. For this reason, after the leading edge of the sheet SH is conveyed to a position beyond the nip portion of the feeding unit 604, the conveyance can be continued by the feeding unit 604 even if the driving of the feeding unit 603 is stopped.

The sensor 631 is a sensor that detects the sheet SH, and is a sensor that detects passage of the leading edge and the trailing edge of the sheet SH. The detection position of the sensor 631 is set to a position on the downstream side of the nip portion of the feeding unit 604. After passage of the leading edge of the sheet SH is detected, the detection result of the sensor 631 can be used as a trigger for conveyance control to, for example, stop driving of the feeding unit 603 or increase the conveyance speed of the feeding unit 604.

The conveying unit 605 is arranged on the upstream side of a printhead 612. The conveying unit 605 conveys the sheet SH to the downstream side between the printhead 612 and a platen facing the printhead 612. The conveying unit 605 includes a conveyance roller 605a, and a driven roller (pinch roller) 605b brought into pressure contact with the conveyance roller 605a by a spring (not shown) or the like. The conveyance roller 605a is a rotating body that is rotated by the driving force of a conveyance motor 624, and the driven roller 605b is a rotating body that rotates following the rotation of the conveyance roller 605a. The sheet SH is clamped in the nip portion between the conveyance roller 605a and the driven roller 605b, and conveyed by the rotation of the conveyance roller 605a and the driven roller 605b.

A sensor 632 is a sensor that detects the sheet SH, and is a sensor that detects passage of the leading edge and the trailing edge of the sheet SH. The sensor 632 is, for example, an optical sensor. Since the sensor 632 is arranged on the upstream side near the conveying unit 605, the detection result can be used to manage the loop amount of registration of the sheet SH or the positions of the leading edge and the trailing edge of the sheet SH.

The conveying unit 606 is arranged on the downstream side of the printhead 612 and conveys the sheet SH conveyed by the conveying unit 605 up to the conveying unit 609 on the downstream side. The conveying unit 606 includes a conveyance roller 606a, and a spur 606b that is brought into pressure contact with the conveyance roller 606a by a spring (not shown) or the like. The conveyance roller 606a is a rotating body that is rotated by the driving force of the conveyance motor 624, and the spur 606b is a rotating body that rotates following the rotation of the conveyance roller 606a. In this embodiment, the conveying unit 605 and the conveying unit 606 share the driving source (conveyance motor 624).

The conveying unit 607 is arranged on the downstream side of the printhead 612 and the conveying unit 606 and conveys the sheet SH conveyed by the conveying unit 606 to the downstream side. The conveying unit 607 includes a conveyance roller 607a, and a spur 607b that is brought into pressure contact with the conveyance roller 607a by a spring (not shown) or the like. The conveyance roller 607a is a rotating body that is rotated by the driving force of the conveyance motor 624, and the spur 607b is a rotating body that rotates following the rotation of the conveyance roller 607a. The sheet SH is clamped in the nip portion between the conveyance roller 607a and the spur 607b and conveyed by the rotation of the conveyance roller 607a and the spur 607b.

A sensor 633 is, for example, an optical sensor and detects the sheet SH, like the sensors 631 and 632. The sensor 633 can be used to detect the leading edge and the trailing edge of the sheet SH or detect the presence/absence of the sheet SH in the conveyance path if a jam of the sheet SH occurs in the conveyance path.

The conveying units 608 and 609 are arranged on the downstream side of the printhead 612 and the conveying units 606 and 607. The conveying units 608 and 609 are discharging units that discharge the sheet SH conveyed by the conveying unit 607 to a discharge tray 617.

The conveying unit 608 includes a conveyance roller 608a, and a spur 608b that is brought into pressure contact with the conveyance roller 608a by a spring (not shown) or the like. The conveyance roller 608a is a rotating body that is rotated by the driving force of a conveyance motor 625, and the spur 608b is a rotating body that rotates following the rotation of the conveyance roller 608a. The sheet SH is clamped in the nip portion between the conveyance roller 608a and the spur 608b and conveyed by the rotation of the conveyance roller 608a and the spur 608b.

The conveying unit 609 includes a conveyance roller 609a, and a spur 609b that is brought into pressure contact with the conveyance roller 609a by a spring (not shown) or the like. The conveyance roller 609a is a rotating body that is rotated by the driving force of the same conveyance motor 625 as that for the conveying unit 608, and the spur 609b is a rotating body that rotates following the rotation of the conveyance roller 609a. The sheet SH is clamped in the nip portion between the conveyance roller 609a and the spur 609b and conveyed by the rotation of the conveyance roller 609a and the spur 609b.

In this embodiment, the conveying unit 608 and the conveying unit 609 share the driving source (conveyance motor 625). However, the motor 625 may be eliminated, and the conveyance motor 624 that is the driving source for the conveying units 605 to 607 may be shared by the conveying unit 608 and the conveying unit 609 as well.

Also, in this embodiment, four conveying units (conveying units 606 to 609) are used on the downstream side of the printhead 612. However, the number of conveying units can be decreased in accordance with the conveyance-direction size of the corresponding printing medium of the printing apparatus 1. For example, only the conveying unit 606 and the conveying unit 609 may be left, and the conveying unit 609 may discharge the sheet SH to the discharge tray 617.

A sensor 634 is a sensor that detects the sheet SH, and is a sensor that detects passage of the leading edge and the trailing edge of the sheet SH, like the sensors 631 to 633. The sensor 634 is, for example, an optical sensor. In this embodiment, after the trailing edge of the sheet SH is detected by the sensor 634, discharge is completed (the trailing edge of the sheet SH reaches the discharge tray 617) after a predetermined conveyance amount. Hence, the detection result of the sensor 634 can be used to detect discharge of the sheet SH.

The printing unit 610 includes the printhead 612, a carriage 611, and a driving unit 614. The printhead 612 discharges liquid ink to the sheet SH, thereby printing an image on the sheet SH. The lower surface of the printhead 612 forms a discharge surface in which a plurality of nozzles for discharging ink are formed.

The ink to be supplied to the printhead 612 is stored in the tank 668. The tank 668 is stored in the storage portion 667. The printhead 612 is mounted on the carriage 611. The carriage 611 is reciprocally moved in a direction (in this embodiment, the X-axis direction) crossing a direction SD by the driving unit 614. The driving unit 614 is a belt transmission mechanism using, for example, a motor 621 as a driving source. The carriage 611 moves while being fixed on a belt (not shown).

An image printing operation will be described next. In the process of reciprocal movement of the carriage 611 in the X-axis direction, ink is discharged from the printhead 612 to the sheet SH, thereby printing an image. This operation is called print scanning. The printing operation is performed by alternately repeating a conveyance operation of intermittently conveying the sheet SH in the direction SD by the conveying unit 605 and print scanning.

The front feeding mechanism of the printing apparatus 1 will be described. By the front feeding mechanism, the sheet SH can manually be supplied from the front side of the printing apparatus 1. In this embodiment, when a cover 653 of the front surface 101a of the printing apparatus 1 is opened, a feeding unit 650 can be unfolded. The feeding unit 650 is provided with an unfoldable stacking tray 651. In a state in which the stacking tray 651 is closed, a plurality of trays are folded and stored inside. In a state in which the stacking tray 651 is open, the plurality of folded trays are unfolded to such a length that can hold the stacked sheet SH without dropping it.

A feeding tray 652 exists deep in the opened stacking tray 651, and the stacked sheet SH is held by both the stacking tray 651 and the feeding tray 652. There is provided a sensor 636 that detects whether the sheet SH is stacked on the feeding tray 652.

The sensor 636 is a sensor that detects the sheet SH, and is, for example, an optical sensor. The sensor 636 detects the presence/absence of the sheet SH on the feeding tray 652 and can also be formed by, for example, a reflection sensor.

The arrangement of the feeding unit 650 and a conveyance path RT6F will be described next. The feeding unit 650 includes a feeding roller 650a to be pressed against the sheet SH stacked on the feeding tray 652. A conveyance roller 650b and a separation roller 650c are provided on the downstream side of the feeding roller 650a. The feeding roller 650a and the conveyance roller 650b are driven using the feeding motor 623 as a driving source. The sheet SH set on the feeding tray 652 is picked up by the feeding roller 650a, separated one by one by the nip portion between the conveyance roller 650b and the separation roller 650c, and fed to the conveyance path RT6A. The sheet SH fed from the feeding unit 650 is conveyed to the conveying unit 605. After that, the sheet SH is conveyed by the conveying unit 605, and an image is printed on it by the printhead 612.

### Opening/Closing Mechanism of Cover Member

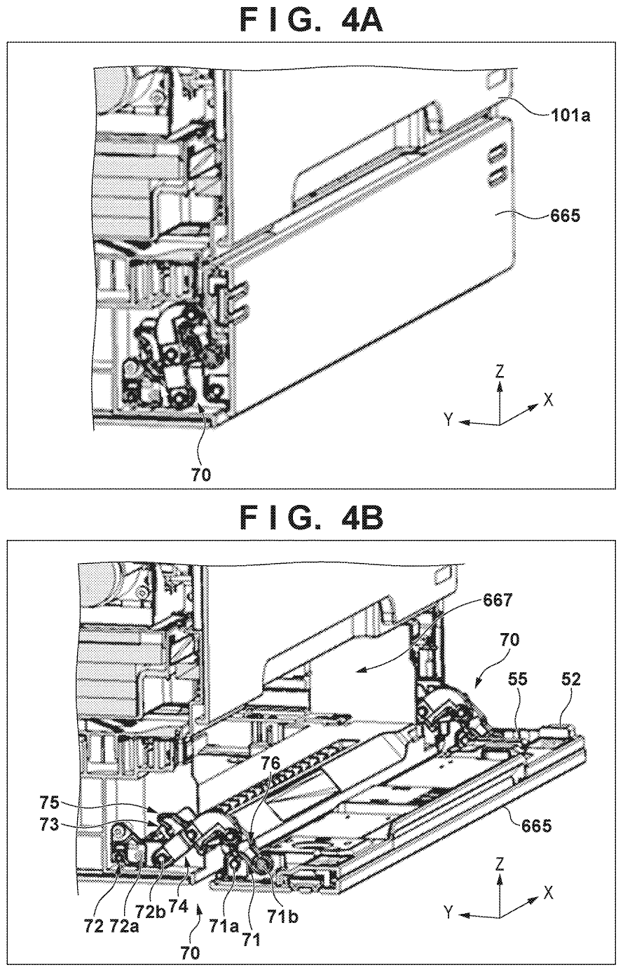

The opening/closing mechanism of the cover member 665 will be described with reference to FIGS. 4A and 4B. FIGS. 4A and 4B are partial cutaway views showing an opening/closing mechanism 70 of the cover member 665. In this embodiment, the opening/closing mechanism 70 is a mechanism that is provided at each end portion of the cover member 665 in the X direction and, on the lower side in the Z direction, rotates the cover member 665 about an axis in the X direction.

The opening/closing mechanism 70 includes hinges 71 to 76. The cover member 665 includes an axial support portion 71a and an axial support portion 71b. The hinge 71 fixed to the cover member 665 supports the axial support portion 71a and the axial support portion 71b. The hinge 72 includes an axial support portion 72a and an axial support portion 72b, which are fixed on the side of the main body 100. The hinge 73 is an indirect hinge axially supported by the axial support portion 72a, and the hinge 74 is an indirect hinge supported by the axial support portion 72b. The hinge 75 is axially supported by the indirect hinge 73 and axially supports the axial support portion 71a. The hinge 76 is axially supported by the indirect hinge 74 and axially supports the axial support portion 71b.

By the opening/closing mechanism 70, the cover member 665 can freely rotate between the closing position shown in FIG. 4A and the opening position shown in FIG. 4B at which the cover member rotates from the closing position to the front side. In a state in which the cover member 665 is at the opening position shown in FIG. 4B, the storage portion 667 is opened to the front side of the printing apparatus 1, and the tank 668 can be exchanged.

### Lock Structure

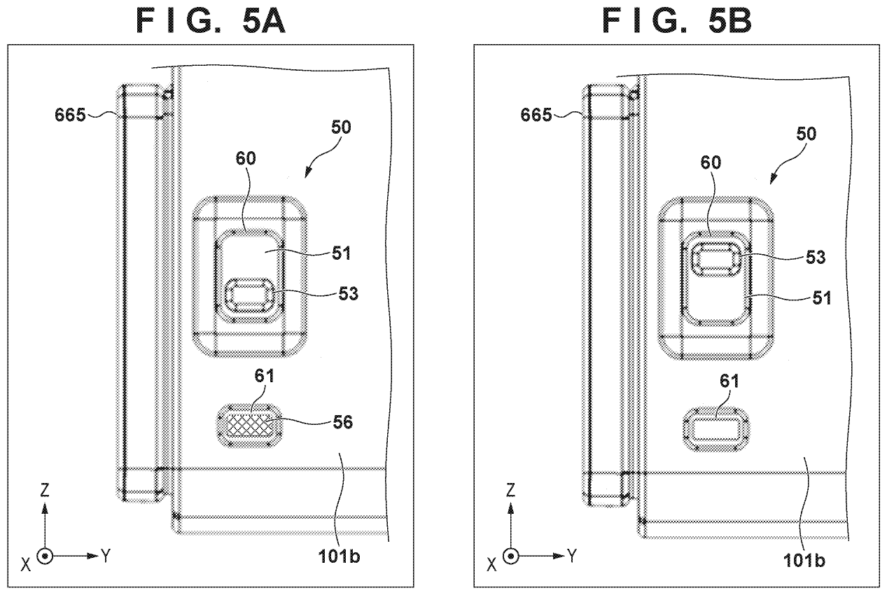

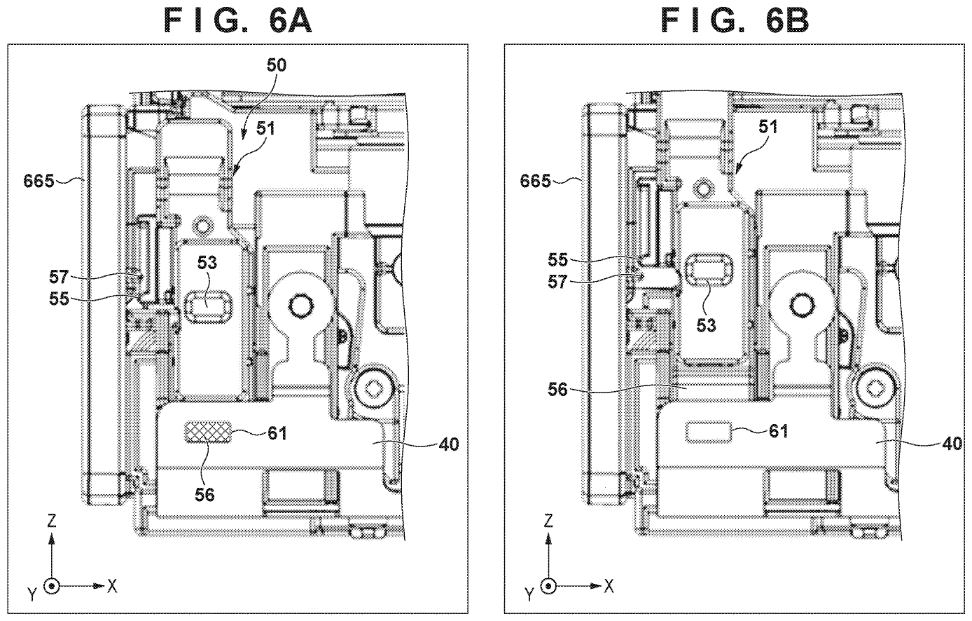

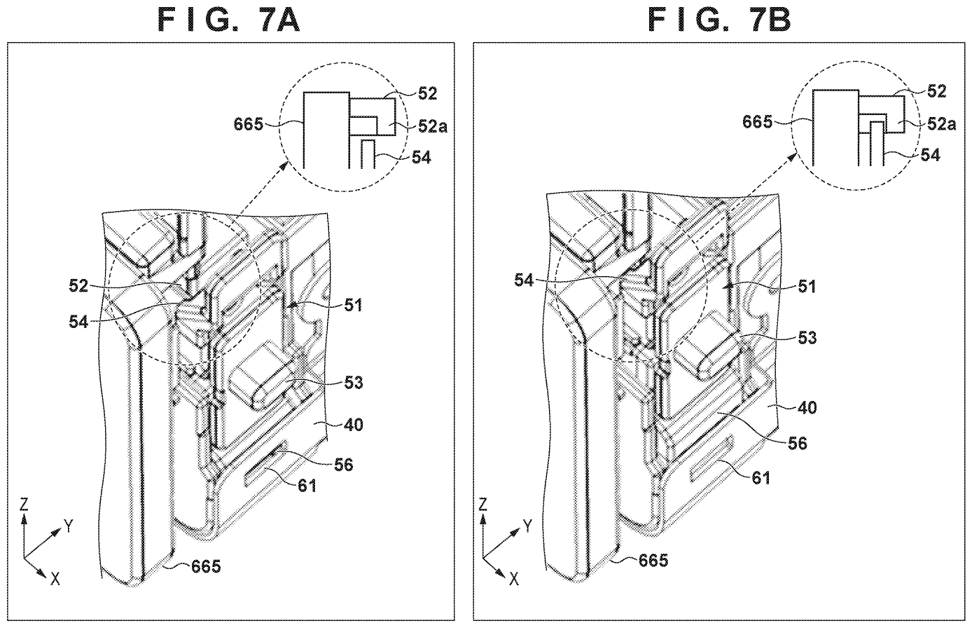

To prevent the tank 668 from being taken out without permission, the printing apparatus 1 has a lock structure that locks the cover member 665. The lock structure includes a restricting mechanism 50 that restricts displacement of the cover member 665, and a slot 61 capable of maintaining a restricted state by a locking tool. FIGS. 5A and 5B are explanatory views of the restricting mechanism 50 and the slot 61, and these are front views of the side surface 101b. FIGS. 6A and 6B are explanatory views of the restricting mechanism 50 and the slot 61 in a state in which the panel that forms the side surface 101b of the housing 101 is detached. FIGS. 7A and 7B are perspective views of the periphery of the restricting mechanism 50 and the slot 61 in the state in which the panel that forms the side surface 101b is detached.

The restricting mechanism 50 includes a restricting member 51 provided on the side of the main body 100. The restricting member 51 is arranged inside the housing 101 and supported such that it can displace between a restriction position to restrict displacement of the cover member 665 from the closing position to the opening position and a restriction releasing position to release the restriction of the displacement of the cover member 665 from the closing position to the opening position. In this embodiment, the restricting member 51 is provided to be slidable in the up/down direction and can displace between the restriction releasing position on the lower side shown in FIGS. 5A, 6A, and 7A and the restriction position on the upper side shown in FIGS. 5B, 6B, and 7B.

An engaging member 52 is provided at the right end portion of the rear surface of the cover member 665 (FIG. 4B). The engaging member 52 includes a wall-shaped engaging portion 52a facing the rear surface of the cover member 665, and has a hook shape on a vertical cross section. An engaging portion 54 having a projection shape that can enter/retreat in/from a groove between the cover member 665 and the engaging portion 52a is formed on the upper portion of the restricting member 51.

If the restricting member 51 is located at the restriction releasing position, the engaging portion 54 is outside the groove between the cover member 665 and the engaging portion 52a, and displacement of the cover member 665 is not restricted by the restricting member 51. On the other hand, if the restricting member 51 is located at the restriction position, the engaging portion 54 is in a state in which it is inserted into the groove between the cover member 665 and the engaging portion 52a. If the cover member 665 is to be displaced from the closing position to the opening position, the engaging portion 54 and the engaging portion 52a contact in the Y direction and engage and, therefore, the cover member 665 cannot be displaced from the closing position to the opening position. The cover member 665 can thus be locked.

The restricting member 51 includes an operation portion 53 that the user can operate. The operation portion 53 has a form of a projecting portion projecting in the X direction. An opening portion 60 is formed in the panel that forms the side surface 101b of the housing 101. The opening portion 60 extends through the panel. The operation portion 53 is inserted into the opening portion 60 and exposed to the side surface 101b. The user can displace the restricting member 51 to the restriction position or the restriction releasing position by sliding the restricting member 51 in the up/down direction via the operation portion 53 from the outside of the housing 101.

In this embodiment, as described above, the restricting member 51 can slide in the up/down direction, and the restriction position of the restricting member 51 is the position on the upper side. The user can easily operate the restricting member 51 from the restriction position to the restriction releasing position, but the restricting member 51 sometimes naturally displaces from the restriction position to the restriction releasing position by its own weight. To prevent the restricting member 51 from displacing from the restriction position to the restriction releasing position by its own weight, a holding unit 55 that holds the restricting member 51 at the restriction position is provided on the restricting member 51.

The holding unit 55 is an engaging claw that is formed at the end portion of the restricting member 51 on the front side in the Y direction and can elastically deform. An engaging portion 57 that engages with the holding unit 55 is formed at the right end portion of the rear surface of the cover member 665. The engaging portion 57 is a projecting portion projecting backward from the rear surface of the cover member 665.

As shown in FIG. 6B, if the restricting member 51 is located at the restriction position, the holding unit 55 is located above the engaging portion 57. If the restricting member 51 is going to move down from the restriction position to the restriction releasing position by its own weight, the holding unit 55 and the engaging portion 57 engage with each other to prevent this. On the other hand, if the user presses the restricting member 51 downward, the holding unit 55 elastically deforms and disengages from the engaging portion 57, and the restricting member 51 displaces from the restriction position to the restriction releasing position.

At the restriction releasing position, the holding unit 55 is located below the engaging portion 57. If the user raises the restricting member 51 from the restriction releasing position to the restriction position, the holding unit 55 and the engaging portion 57 temporarily engage, but these are disengaged due to elastic deformation of the holding unit 55, and the restricting member 51 displaces to the restriction position. By the temporary engagement between the holding unit 55 and the engaging portion 57 and disengagement thereof, when the restricting member 51 displaces from the restriction releasing position to the restriction position, the user can feel a click and intuitively sense the displacement of the restricting member 51 to the restriction position.

The slot 61 is formed on the lower side of the opening portion 60. The slot 61 is formed to extend through the panel that forms the side surface 101b of the housing 101 and a metal frame 40 inside.

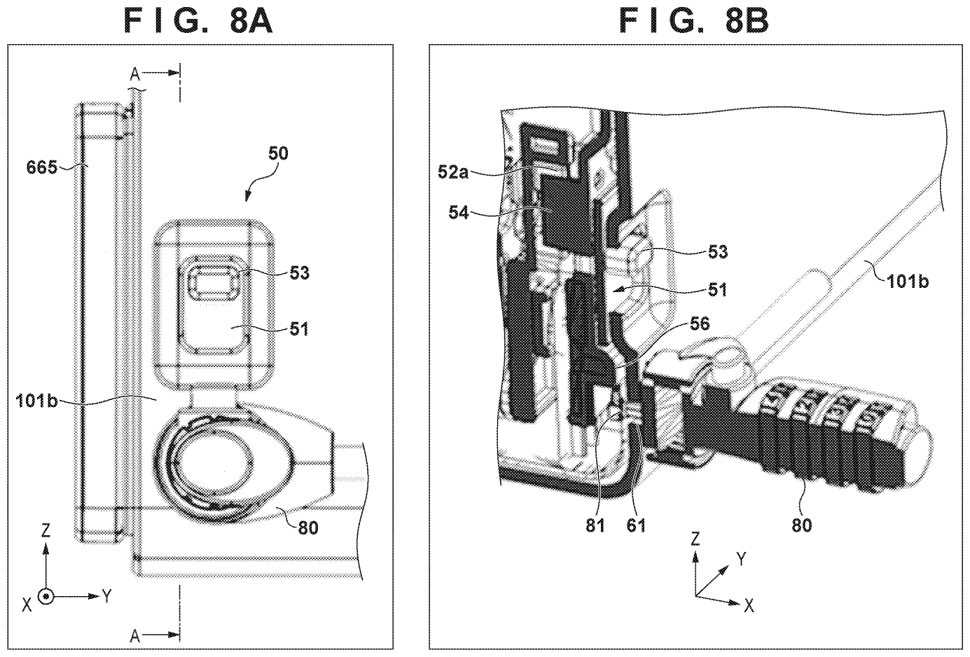

The slot 61 forms a security hole, and a lock member is inserted here, thereby locking the restricting member 51 to the restriction position and preventing the restricting member 51 from displacing from the restriction position to the restriction releasing position. FIG. 8A shows a state in which a locking tool 80 such as a Kensington lock is attached to the slot 61, and FIG. 8B is a perspective view showing a cross section taken along a line A-A in FIG. 8A. The locking tool 80 includes a lock member 81 to be inserted into the slot 61, and when a locking operation is performed for the locking tool 80, the lock member 81 cannot be removed from the slot 61.

A shutter portion 56 is formed on the lower side of the restricting member 51. The shutter portion 56 is located inside the frame 40 in the X direction and overlaps the slot 61 to close this when the restricting member 51 is located at the restriction releasing position (see FIGS. 5A, 6A, and 7A). When the restricting member 51 is located at the restriction position, the shutter portion 56 is located on the upper side of the slot 61 to open the slot 61 (see FIGS. 5B, 6B, and 7B).

In a state in which the restricting member 51 is located at the restriction position and the slot 61 is open, the lock member 81 of the locking tool 80 is inserted into this, and the locking operation is performed for the locking tool 80. Even if the restricting member 51 is to be displaced from the restriction position to the restriction releasing position, it cannot be displaced because the shutter portion 56 interferes with the lock member 81. If the restricting member 51 is at the restriction releasing position, the lock member 81 cannot be inserted into the slot 61 because the slot 61 is closed by the shutter portion 56. Hence, an operation error can be prevented.

As described above, according to this embodiment, the cover member 665 can be locked to the closing position by the restricting mechanism 50 and the attachment of the locking tool 80 to the slot 61. As for the lock structure, applicable housings are not particularly limited, and the degree of freedom of application targets can be improved.

### Other Embodiments

In the above-described embodiment, an example in which the cover member 665 opens/closes the storage portion 667 in which the tank 668 storing ink is stored has been described. However, for example, the cover member may open/close a storage portion in which a printing medium such as the sheet SH is stored, and the lock structure may lock the cover member. Also, for example, if the electrical device is an electrophotographic type image forming apparatus, the cover member may open/close a storage portion in which a toner bottle is stored, and the lock structure may lock the cover member. Also, for example, if the electrical device is an apparatus to be driven using a battery as a power supply, the cover member may open/close a storage portion in which the battery is stored, and the lock structure may lock the cover member.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-063890, filed Apr. 8, 2025 which is hereby incorporated by reference herein in its entirety.

What is claimed is:

1. An electrical device comprising:
a main body including a storage unit in which consumables are stored;
a cover member supported by the main body so as to be displaceable between a first position to over the storage unit and a second position to expose the storage unit;
a restricting member provided on the main body so as to be displaceable between a restriction position to restrict displacement of the cover member from the first position to the second position and a restriction releasing position to release the restriction of the displacement of the cover member; and
a slot formed in a housing of the main body, into which a locking member is inserted to prevent the restricting member from displacing from the restriction position to the restriction releasing position.

2. The device according to claim 1, wherein
the slot is closed by the restricting member in a case where the restricting member is located at the restriction releasing position and opened in a case where the restricting member is located at the restriction position.

3. The device according to claim 1, wherein
the restricting member is configured to displace in an up/down direction, and
the restriction position is a position on an upper side of the restriction releasing position.

4. The device according to claim 3, further comprising
a holding unit configured to hold the restricting member at the restriction position such that the restricting member does not displace from the restriction position to the restriction releasing position by its own weight.

5. The device according to claim 1, wherein
the electrical device includes a front surface,
the cover member forms a part of the front surface at the first position, and
in a case where the cover member is located at the second position, the part of the front surface opens, and the storage unit is exposed.

6. The device according to claim 4, wherein
the electrical device includes a side surface formed by the housing, and
the slot opens to the side surface.

7. The device according to claim 6, wherein
the restricting member includes an operation portion configured to be operable by a user, and
an opening portion to expose the operation portion is formed in the side surface.

8. The device according to claim 7, wherein the opening portion is formed on an upper side of the slot.

9. The device according to claim 1, wherein
the electrical device is a printing apparatus configured to perform printing by discharging a liquid to a printing medium, and
a tank that stores the liquid as the consumables is stored in the storage unit.
